(19) United States
(12) Patent Application Publication
(10) Pub. No.: US 2025/0113178 A1
(43) Pub. Date: Apr. 3, 2025

(54) METHOD FOR IDENTIFYING ITEMS OF EQUIPMENT PRESENT IN A HOME NETWORK

(71) Applicant: SOFTATHOME, COLOMBES (FR)

(72) Inventor: Romain PICARD, LE PERCHAY (FR)

(21) Appl. No.: 18/727,001

(22) PCT Filed: Jan. 4, 2023
(86) PCT No.: PCT/EP2023/050129

§ 371 Date: Aug. 9, 2024

(30) Foreign Application Priority Data
Jan. 4, 2022 (FR) FR2200032

(51) Int. Cl. H04W 8/22; H04L 41/16

(52) U.S. Cl. CPC H04W 8/22; H04L 41/16

(57) ABSTRACT

A method for identifying a first item of equipment present in a communication network, this method being implemented by a processing unit and including the following steps: —receiving identification data from the first item of equipment, —using a neural network-based statistical model to compute a digital fingerprint of the first item of equipment based on the identification data, —successively determining distances between the computed digital fingerprint and, respectively, digital fingerprints pre-recorded in a reference base; these pre-recorded digital fingerprints being digital fingerprints of known items of equipment, —identifying the first item of equipment as being a known item of equipment when the distance between the digital fingerprint of the first item of equipment and the pre-recorded digital fingerprint of the known item of equipment is less than a predetermined threshold.

The present invention relates to a method for identifying a first item of equipment present in a communication network.

Generally speaking, the identification of equipment items in a home network is based on machine learning solutions of the multi-class classification type. These solutions are all based on environments composed of twenty to thirty different equipment items.

A telecom operator's environment is very different. Millions of users use several thousand models of equipment items. What is more, some of these equipment items are very popular and much more prevalent than others (several hundred thousand times more). Having several thousand classes and a very unbalanced model distribution makes the multi-class classification approach unsuitable for networks of several thousand devices.

Document US20200382376A1 discloses a method for classifying an item of equipment by assigning it to a first category using a first classification technique for a predetermined period of time. A second classification technique is applied if the item of equipment has not changed category within the predetermined time.

U.S. Pat. No. 10,652,116B2 discloses an equipment classification method. A variety of information is used to enable classification.

The aim of the present invention is to identify a very large number of equipment items.

Another aim of the invention is to design a new identification method which is capable of easily identifying a wide range of new equipment items.

Another aim of the invention is to develop a new identification method which is capable of reliably recognizing less popular equipment items.

At least one of the objectives is achieved with a method for identifying a first item of equipment present in a communication network, in particular a home network, this method being implemented by a processing unit and comprising the following steps:
receiving identification data from said first item of equipment,
using a neural network-based statistical model to compute a digital fingerprint of the first item of equipment based on the identification data,
successively determining distances between the computed digital fingerprint and, respectively, digital fingerprints pre-recorded in a reference base; these pre-recorded digital fingerprints being digital fingerprints of known items of equipment,
identifying the first item of equipment as being a known item of equipment when the distance between the digital fingerprint of the first item of equipment and the pre-recorded digital fingerprint of said known item of equipment is less than a predetermined threshold.

The method according to the invention uses a new digital fingerprinting approach, rather than classification as in the prior art. In particular, the invention makes it possible to recognize items of equipment that were not known when the model was trained.

The distance of the item of equipment to be identified can advantageously be computed in relation to all the fingerprints in the reference base, in particular using a KNN (K nearest neighbors) type algorithm. This makes it possible to know which item of equipment in the reference base is most similar to the item of equipment to be identified.

The statistical model is based on machine learning technology using neural networks. The input data is used to predict a digital fingerprint. A search is then initiated in the reference base to find a pre-recorded digital fingerprint that most closely matches or resembles the fingerprint just predicted or determined.

The invention uses machine learning instead of a simple signature creation algorithm. The use of machine learning is less time-consuming.

Identifying an item of equipment involves identifying the operating system and the type of equipment.

Preferentially, the following information can be identified for each item of equipment:
the type of equipment, e.g. computer, camera, TV, etc.,
the seller of the equipment, e.g. “Apple”, etc.,
the product line of the equipment, e.g. “iPhone”, etc.,
the equipment model, e.g. an “iPhone 13 Pro Max”, etc.,
the operating system used by the item of equipment, e.g. “iOS”, etc.,
the version of the operating system used by the item of equipment, e.g. “15.1.0”, etc.

The invention enables a very large number of equipment types to be detected by using machine learning to generate a digital fingerprint and comparing it with digital fingerprints contained in a reference base.

The use of machine learning and the reference base means that the number of fingerprints in the reference base is limited. In fact, the comparison is not necessarily done identically, but looking for a digital fingerprint that is as close as possible. There is thus no need to list the exact fingerprint of every item of equipment.

The result is a non-exhaustive reference base.

In the method according to the invention, if the item of equipment is not recognized, a manual or automatic method can be set up to retrieve a set of data from the item of equipment being identified. This can be done by means of an application communicating with the item of equipment. The item of equipment's digital fingerprint can then be stored in the reference base.

According to an advantageous feature of the invention, the pre-recorded digital fingerprints can be vectors obtained from identification data of known items of equipment.

In addition to the above, each vector can be determined from:
on the one hand, identification data containing textual information whereupon processing is applied by means of a subset of the neural network based on recurrent neurons to determine a first sub-vector,
identification data containing categorical information, whereupon ordinal encoding is applied to determine a unique code for each category, followed by embedding to associate each category with a second sub-vector,
the first and second sub-vectors are then combined by means of at least one dense layer to form said vector.

In particular, each category is transformed into a single sub-vector.

According to an embodiment of the invention, the subset of the neural network based on recurrent neurons can be a recurrent network of the LSTM (“Long Short Term Memory”) or GRU (“Gated Recurrent Unit”) type. Other types of approach can be envisaged, such as attention layers, like transformers.

According to one embodiment of the invention, for a given item of equipment, the statistical model can comprise a triplet loss function to generate a vector closer to the vectors of items of equipment identical to said given item of equipment and further away from the vectors of items of equipment different from said given item of equipment.

Such an embodiment involves analyzing not only likelihoods but also differences.

According to one embodiment of the invention, for a given item of equipment, the statistical model can comprise a contrastive loss function to generate a vector closer to the vectors of items of equipment identical to said given item of equipment and further away from the vectors of items of equipment different from said given item of equipment.

According to the invention, the pre-recorded digital fingerprints can be predetermined by the neural network from the following data of known items of equipment:
DHCP protocol identifiers including hostname, options, vendor class and list of options in a request packet,
the first three bytes of the MAC address (OUI),
service names from mDNS announcements, e.g. ptrs fields from mDNS announcements,
WiFi data,
client and server TLS fingerprints, for example in JA3 format,
the list of domain names contacted,
the number of different domain names contacted,
list of network ports used (TCP and UDP),
list of open network ports (TCP and UDP),
network communication time information including WiFi and DHCP server connection frequency, and/or domain name network access frequency, and
network connection type: WiFi or Ethernet.

In addition to the above, WiFi data can comprise:
HT/VHT/HE capacities,
the first three bytes of the supplier-specific label,
the number of antennas,
the list of supported MCS (“Modulation and Coding Scheme”),
maximum bandwidth supported,
UNII (“Unlicensed National Information Infrastructure”) band capacities,
spatial flow: maximum rx/tx supported,
supported standards,
supported radio standards.

According to an advantageous implementation of the invention, the identification data comprises at least one of the following:
a user agent in an HTTP or QUIC protocol,
DHCP protocol identifiers comprising hostname, vendor class, user class and vendor specific information,
service names of mDNS announcements, e.g. “_printer._tcp”, and
UPnP protocol data comprising: manufacturer, familiar name, model, description, model number.

With at least one of these data, it is possible to identify an item of equipment.

According to a preferred embodiment of the invention, before using the statistical model, the identification data can first be fed to an expert system capable of identifying the item of equipment or transmitting the identification data to the statistical model if identification fails, the expert system comprising an equipment recognition algorithm based on regular expression rules.

With such an embodiment, the present invention constitutes a hybrid solution comprising an expert system and a machine learning solution. An initial test is carried out with the expert system: if the item of equipment is identified, the algorithm stops; otherwise, the identification data is sent to the statistical model for identification. If the statistical model fails to identify the item of equipment, human intervention may or may not be required to create a digital fingerprint of the item of equipment and record it in the reference base.

The expert system uses regular expression-based rules to recognize certain characteristic patterns. These rules use identification data to identify an item of equipment.

Advantageously, the reference base can comprise digital fingerprints obtained from data gathered from information collections and fingerprints obtained from data synthesized from a generator.

The data collected comes from retrieving information from listed items of equipment or from queries that have been made. Otherwise, the data collected consists of a sampling of the queries made. This sampling is done in such a way as to have a sufficient number of examples for each item of equipment to be recognized. It is important in this sampling to balance the number of samples for each type of equipment item.

For items of equipment with a low presence rate, the data generator can be used to generate a sufficient number of examples to add to the reference base.

The generator used for the reference base can also be used during the model training phase. In this case, it is used to rebalance data distribution. Balancing the distribution of classes when training a model is crucial to its subsequent performance.

Thus, the reliability of the system's prediction depends on the amount and type of information it receives as input. To do this, the data used is balanced as much as possible:
by deleting data from the most popular items of equipment, and
using synthetic data for rarer items of equipment.

The present invention also relates to a computer program product comprising instructions which, when the program is executed by a computer, cause the latter to implement the method disclosed above.

A data processing system is also provided, comprising a processor adapted to the method disclosed above.

Other benefits and features of the invention will become evident upon examining the detailed description of an entirely non-limiting implementation, and from the enclosed drawings wherein:

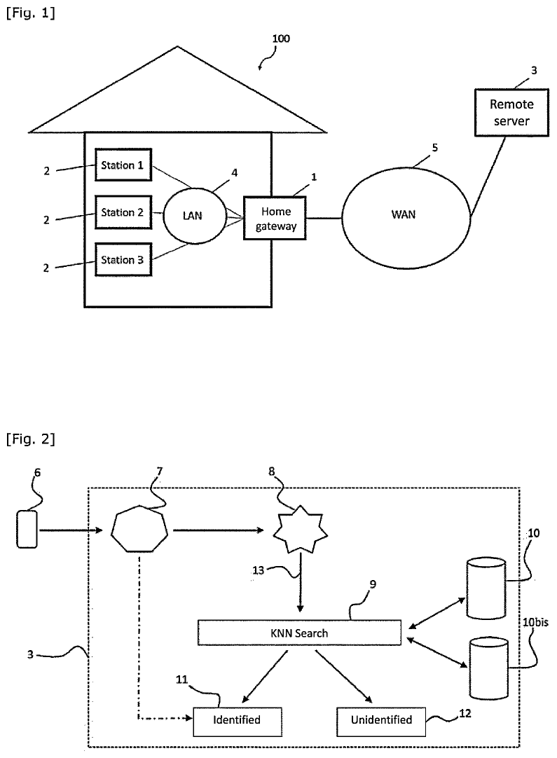

FIG. 1 is a schematic overview of an operator system;

FIG. 2 is a schematic view of various identification steps for an equipment item according to the invention; and

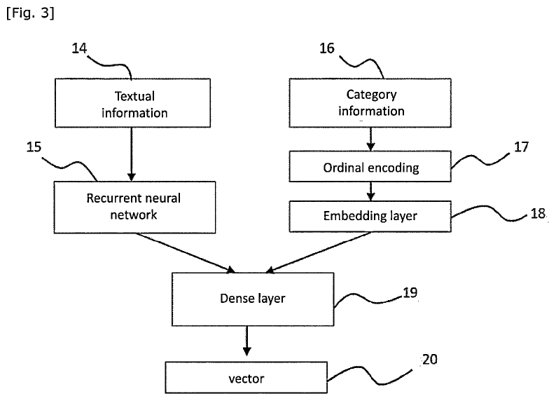

FIG. 3 is a schematic view of an example of the architecture of a neural network according to the invention.

The embodiments which will be disclosed hereinafter are in no way limiting; in particular, it is possible to implement variants of the invention that comprise only a selection of the features disclosed hereinafter in isolation from the other features disclosed, if this selection of features is sufficient to confer a technical benefit or to differentiate the invention with respect to the prior art. This selection comprises at least one preferably functional feature which lacks structural details, or only has a portion of the structural details if that portion only is sufficient to confer a technical benefit or to differentiate the invention with respect to the prior state of the art.

With reference to FIG. 1, we will first disclose a wireless home local area network 100. The center of the network is a home gateway 1 distributing an Internet connection to the various stations 2 connected in the home. The home gateway 1 is placed in the home, in the living room for example. The home gateway 1 is the central point for all flows: images, music, video, etc. Each station 2 is connected by WiFi or Ethernet cable to the gateway. The home gateway 1 is connected, on the one hand, to the home's Local Area Network (LAN) 4 and, on the other hand, to the external Wide Area Network (WAN) 5. The local area network 4 refers to any interconnected computer system or station 2 in the user's home, such as a TV, tablet, cell phone or games console. A remote server 3, such as a telecom operator's server, is connected to the local area network 4 via the external network 5. The home gateway 1 is, for example, a device from the aforementioned telecom operator.

The purpose of the present invention is to identify any item of equipment connecting to the telecom operator's devices. To achieve this, an algorithm according to the invention is implemented in the remote server 3.

The context of the home local area network is provided as an example. The method disclosed by the present invention is applicable to other types of wireless communication networks, for example a university network, corporate networks, etc.

FIG. 2 is an overview of the device according to the invention.

An equipment item such as a cell phone 6 connects to the server 3. The latter will implement the method according to the invention to identify this cell phone, that is, to identify the following elements:
the type of equipment, e.g. computer, camera, TV, etc.,
the equipment vendor,
the equipment product line,
the equipment model,
the operating system used by the item of equipment, and
the version of the operating system used by the item of equipment.

The minimum needed to identify an item of equipment, for example, is its operating system and equipment type.

Once the item of equipment has been identified, the result can be:
displayed on a display device either for the equipment owner or for a customer support service to help solve problems,
used in other services such as quality of service (adapting network configuration to each item of equipment), IT security (detecting that an item of equipment requires a software update, isolating an item of equipment, etc.), physical security (detecting abnormal behavior indicating a possible burglary), etc.

The result is data that can be transmitted to another processing device.

The server 3 comprises hardware and software components for implementing the invention. However, these components can be integrated into a single device, or distributed across several devices, near or far.

The server 3 comprises an expert system 7, a neural network-based statistical model 8, a search algorithm 9, a reference base 10 and outputs 11 and 12.

When the telephone 6 connects to the telecom operator's network, identification data for this telephone is transmitted to the server 3. The expert system 7 applies its rules.

If the telephone 6 is already known to the expert system, then this telephone is identified in 11.

If the telephone 6 connects for the first time, the expert system deduces that this telephone is unknown. The identification data is then sent to the statistical model 8, which generates a digital fingerprint 13.

The knn search algorithm 9 is used to search the reference base 10 for a pre-recorded digital fingerprint that is close to the digital fingerprint 13. A distance between the digital fingerprint 13 and each pre-recorded digital fingerprint is tested. When this distance is less than a predetermined threshold, then the digital fingerprint 13 is considered to be the pre-recorded digital fingerprint that allows passage below the threshold. In this case, the identification is confirmed in 11. Reference 11 can be a visual or audible output device, a database entry, or the like. For example, information can be sent to the recognized item of equipment.

When the telephone is identified, services can be unblocked or information exchanged between the recognized item of equipment and the server 3 or any other device.

If the telephone is not recognized in the reference base, the digital fingerprint 13 is placed in a prediction base 10bis. Human intervention can then be used to manually identify the item of equipment and place its signature in the reference base, associating it with the telephone 6.

In fact, when an item of equipment is not recognized, its digital fingerprint is only added to the reference base after the item of equipment has been manually identified. In the meantime, the data associated with this item of equipment is stored in a second database, the prediction database 10bis, which contains a list of predictions already made.

The present invention makes advantageous use of machine learning not to predict and identify the device, but to generate a digital fingerprint. This saves time, as one database is used to quickly search for a nearby digital fingerprint.

Given the large number of devices to be identified for a given operator, using machine learning to directly identify the device would be too time-consuming.

The statistical model can be updated, as can the reference base, according to the fingerprints received from the same device. A fingerprint on the same device may change, for example, as a result of equipment upgrades.

All identification requests, for example, are stored in the prediction base 10bis for statistical purposes and to improve the reference base and neural network.

The neural network uses the following information:
DHCP protocol identifiers including hostname, options, vendor class and list of options in a request packet,
the first three bytes of the MAC address (OUI),
service names of mDNS announcements,
WiFi data:
HT/VHT/HE capacities,
the first three bytes of the supplier-specific label,
the number of antennas,
the list of supported MCS (“Modulation and Coding Scheme”),
maximum bandwidth supported,
UNII (“Unlicensed National Information Infrastructure”) band capacities,
spatial flow: maximum rx/tx supported,
supported standards,
supported radio standards,
TLS client and server fingerprints,
the list of domain names contacted,
the number of different domain names contacted,
list of network ports used (TCP and UDP),
list of open network ports (TCP and UDP),
network communication time information including WiFi and DHCP server connection frequency, and/or domain name network access frequency, and
network connection type: WiFi or Ethernet.

Other sources of information can be added to improve the statistical model.

The neural network takes the information listed above as input, and converts it into a vector. The input information is used either directly or encoded.

FIG. 3 is a schematic view of a simplified architecture of a neural network according to the invention.

The textual information 14 such as the “hostname” is used as is, and processed by a subset 15 of the neural network based on “recurrent” neurons, for example of the LSTM or GRU type. Other text processing approaches, such as “attention”, can be used for this type of data. A first sub-vector is created. The subset 15 allows identification of patterns characteristic of certain devices, for example from their “network” name (dhcp hostname, mdns name, upnp friendly name). For example, during training, the model will learn that the text “iPhone”® is common to the iPhone® product line. Conversely, it will learn to ignore patterns that are common in names but not significant for equipment identification. For example, in a network name like “iphone-de-romain”, the model will have learned that the “romain” part is not significant, as it is present in several different devices.

Categorical information 16, such as the TLS fingerprint, is first encoded by ordinal encoding 17 as a single number per category. These categories are then used in an “embeddings” layer 18 which associates each category with a second sub-vector that will be learned when the statistical model is trained.

The first sub-vector and the second sub-vector feed several dense layers 19 to combine sub-vectors and form said vector 20.

The neural network is trained with the aim of generating vectors that are close for identical items of equipment, and far apart for different items of equipment. This can be done in a number of ways, such as using a triplet loss function or a contrastive loss or contrastive learning function.

The triplet loss tells the model which examples are identical and which are different. This learning process uses triplets of examples: two examples from the same class and one from another class. The model is then explicitly trained to strongly separate different examples and to group similar examples together as much as possible.

Contrastive learning does not require different examples, but only examples from the same class. The model is then trained to group similar examples together. The separation of different examples is implicit.

The reference base is made up of two different sources of information:
data from collecting information on queries that have already been made,
data synthesized from a generator.

The data from collection consists of a sampling the queries made. This sampling is done in such a way as to have a sufficient number of examples for each item of equipment to be recognized. It is preferable in this sampling to balance the number of samples for each type of equipment item.

For items of equipment with a low presence rate, the data generator can be used to generate a sufficient number of examples to add to the reference base.

The generator used for the reference base can also be used during the model training phase. In this case, it is used to rebalance data distribution. Balancing the distribution of classes when training a model yields good performance.

Generally speaking, the present invention comprises two steps:
a first step consisting of a neural network-based statistical model that computes a digital fingerprint of the item of equipment to be recognized, and
a second step, which consists in finding this fingerprint in a database of known equipment items. This search is carried out by computing the distance between the fingerprint of the item of equipment to be searched and that of known item of equipment. If a known item of equipment is at a sufficiently short distance from the item of equipment to be recognized, then it is considered a match.

Of course, the invention is not limited to the examples disclosed above. Many modifications can be made to these examples without departing from the scope of the present invention as disclosed.

1. A method for identifying a first item of equipment present in a communication network, this method being implemented by a processing unit and comprising the following steps:
receiving identification data from said first item of equipment;
using a neural network-based statistical model to compute a digital fingerprint of the first item of equipment based on the identification data;
successively determining distances between the computed digital fingerprint and, respectively, digital fingerprints pre-recorded in a reference base; these pre-recorded digital fingerprints being digital fingerprints of known items of equipment; and
identifying the first item of equipment as being a known item of equipment when the distance between the digital fingerprint of the first item of equipment and the pre-recorded digital fingerprint of said known item of equipment is less than a predetermined threshold.

2. The method according to claim 1, characterized in that the pre-recorded digital fingerprints are vectors obtained from identification data of known items of equipment.

3. The method according to claim 2, characterized in that each vector is determined from:
on the one hand, identification data containing textual information whereupon processing is applied by means of a subset of the neural network based on recurrent neurons to determine a first sub-vector;
identification data containing categorical information, whereupon ordinal encoding is applied to determine a unique code for each category, followed by embedding to associate each category with a second sub-vector; and
the first and second sub-vectors are then combined by means of at least one dense layer to form said vector.

4. The method according to claim 3, characterized in that the subset of the neural network based on recurrent neurons is a recurrent network of the LSTM (“Long Short Term Memory”) or GRU (“Gated Recurrent Unit”) type.

5. The method according to claim 3, characterized in that, for a given item of equipment, the statistical model comprises a triplet loss function to generate a vector closer to the vectors of items of equipment identical to said given item of equipment and further away from the vectors of items of equipment different from said given item of equipment.

6. The method according to claim 3, characterized in that, for a given item of equipment, the statistical model comprises a contrastive loss function to generate a vector closer to the vectors of items of equipment identical to said given item of equipment and further away from the vectors of items of equipment different from said given item of equipment.

7. The method according to claim 1, characterized in that the pre-recorded digital fingerprints are predetermined by the neural network from the following data of known items of equipment:
DHCP protocol identifiers including hostname, options, vendor class and list of options in a request packet,
the first three bytes of the MAC address (OUI),
service names of mDNS announcements,
WiFi data,
TLS client and server fingerprints,
the list of domain names contacted,
the number of different domain names contacted,
list of network ports used (TCP and UDP),
list of open network ports (TCP and UDP),
network communication time information including WiFi and DHCP server connection frequency, and/or domain name network access frequency, and
network connection type: WiFi or Ethernet.

8. The method according to claim 7, characterized in that the WiFi data comprise:
HT/VHT/HE capacities,
the first three bytes of the supplier-specific label,
the number of antennas,
the list of supported MCS (“Modulation and Coding Scheme”),
maximum bandwidth supported,
UNII (“Unlicensed National Information Infrastructure”) band capacities,
spatial flow: maximum rx/tx supported,
supported standards,
supported radio standards.

9. The method according to claim 1, characterized in that the identification data comprises at least one of the following data:
a user agent in an HTTP or QUIC protocol,
DHCP protocol identifiers comprising hostname, vendor class, user class and vendor specific information,
service names of mDNS announcements, and
UPnP protocol data comprising: manufacturer, familiar name, model, description, model number.

10. The method according to claim 1, characterized in that before using the statistical model, the identification data are first fed to an expert system capable of identifying the item of equipment or transmitting the identification data to the statistical model if identification fails, the expert system comprising an equipment recognition algorithm based on regular expression rules.

11. The method according to claim 1, characterized in that the reference base comprises digital fingerprints obtained from data gathered from information collections and digital fingerprints obtained from data synthesized from a generator.

12. A computer program product comprising instructions which, when the program is executed by a computer, cause the latter to implement the method according to claim 1.

13. A data processing system comprising a processor adapted to the method according to claim 1.
